(19) United States
(12) Patent Application Publication
(10) Pub. No.: US 2008/0143707 A1
(43) Pub. Date: Jun. 19, 2008

(54) Texture-based multi-dimensional medical image registration

(75) Inventor: Ross Mitchell, Calgary (CA)

Correspondence Address: FREEDMAN & ASSOCIATES, 117 CENTREPOINTE DRIVE, SUITE 350, NEPEAN, ONTARIO, K2G 5X3, omitted

(73) Assignee: Calgary Scientific Inc., Calgary (CA)

(21) Appl. No.: 11/987,187

(22) Filed: Nov. 28, 2007

Related U.S. Application Data
(60) Provisional application No. 60/861,248, filed on Nov. 28, 2006.

(51) Int. Cl. G06F 17/00

(52) U.S. Cl. 345/418

(57) ABSTRACT

The present invention relates to a method for registering multi-dimensional image data. First and second multi-dimensional texture datasets are determined in dependence upon received first and second multi-dimensional image datasets, respectively. Initial transform data are then provided. The second multi-dimensional texture dataset is then transformed and interpolated using the transform data. Difference metric data are determined in dependence upon the first multi-dimensional texture dataset and the transformed second multi-dimensional texture dataset. Using an improvement process the transform data are adjusted. The transformation and adjustment of the transform data is iterated until a stopping criterion is satisfied. Use of texture data allows employment of a texture unit of a graphics processor for the transformation, the interpolation and the determination of the difference metric data.

This application claims the benefit of U.S. Provisional Patent Application No. 60/861,248 filed Nov. 28, 2006, the entire contents of which are incorporated herein by reference.

### FIELD OF THE INVENTION

This invention relates to image processing and in particular to a texture-based data processing method for registering multi-dimensional medical images.

### BACKGROUND OF THE INVENTION

In modern clinical settings medical imaging is a vital component of a large number of applications. Medical imaging is not limited to diagnostics but is also used, for example, in planning, execution and evaluation of surgical and therapeutical procedures.

In numerous applications information gained from two images is of complementary nature and proper fusion of the two images is often desired. In order to properly fuse two images it is necessary to spatially align the image data of the two images using a process called “image registration”.

Using multi-modality registration two images acquired using different image capturing processes are fused. For example, in epilepsy surgery images are acquired using various image capturing processes such as Magnetic Resonance Imaging (MRI), Computed Tomography (CT), and Digital Subtraction Angiography (DSA). Registration of images for any combination will benefit the surgeon. In radiotherapy treatment, as another example, CT imaging is employed to accurately determine the radiation dose and MRI imaging is employed to delineate tumor tissue.

Besides multi-modality registration, there are also useful applications of single-modality registration, i.e. registration of two images acquired using a same image capturing process. Examples include: treatment verification by comparing pre- and post-intervention images; comparison of ictal and inter-ictal—during and between seizures—Single Photon Emission Computed Tomography (SPECT) images; and growth monitoring—time series of MRI scans of a tumor or time series of X-ray images of a bone structure.

Development of computer graphics hardware is advancing at a rapid rate providing powerful programmable Graphics Processing Units (GPUs). A state of the art method for registering two 3D images using a GPU is disclosed in US Patent Application 2005/0190189. Unfortunately, this method still requires a substantial amount of processing time due to the numerical evaluation of a partial differential equation.

It would be highly desirable to overcome the drawbacks of the state of the art by providing a method for multi-dimensional medical image registration that is substantially faster.

### SUMMARY OF THE INVENTION

It is, therefore, an object of embodiments of the invention to provide a method for registering multi-dimensional medical image data that is substantially faster.

In accordance with the present invention there is provided a method for registering multi-dimensional image data comprising:

a) providing a first and a second multi-dimensional image dataset, the first and the second multi-dimensional image dataset being indicative of an image of one of an object and a physical event;
b) determining a first and a second multi-dimensional texture dataset in dependence upon the first and the second multi-dimensional image dataset, respectively;
c) providing transform data;
d) transforming and interpolating the second multi-dimensional texture dataset using the transform data;
e) determining difference metric data in dependence upon the first multi-dimensional texture dataset and the transformed second multi-dimensional texture dataset;
f) using an optimization process adjusting the transform data in dependence upon the difference metric data; and,
g) iterating d) to f) until a stopping criterion is satisfied.

In accordance with the present invention there is further provided a method for registering multi-dimensional image data comprising:

a) providing a first and a second multi-dimensional image dataset, the first and the second multi-dimensional image dataset being indicative of an image of one of an object and a physical event;
b) determining a first and a second multi-dimensional texture dataset in dependence upon the first and the second multi-dimensional image dataset, respectively;
c) generating a nonlinear vector deformation field texture dataset using transform data indicative of an identity transform;
d) using a texture unit of one of a Graphics Processing Unit (GPU) and General Purpose Graphics Processing Unit (GPGPU) transforming the second multi-dimensional texture dataset by indexing the nonlinear vector deformation field texture dataset producing a deformation index and using the deformation index indexing the second multi-dimensional texture dataset;
e) using the texture unit of the one of a GPU and GPGPU determining difference metric data in dependence upon the first multi-dimensional texture dataset and the transformed second multi-dimensional texture dataset;
f) using an optimization process adjusting the transform data in dependence upon the difference metric data;
g) using the texture unit of the one of a GPU and GPGPU adjusting the nonlinear vector deformation field texture dataset using the adjusted transform data;
h) iterating d) to g) until a stopping criterion is satisfied; and,
i) providing at least one of the transformed second multi-dimensional texture dataset and the transform data.

In accordance with the present invention there is yet further provided a method for registering multi-dimensional image data comprising:

a) providing a first and a second multi-dimensional image dataset, the first and the second multi-dimensional image dataset being indicative of an image of one of an object and a physical event;
b) determining a first and a second multi-dimensional texture dataset in dependence upon the first and the second multi-dimensional image dataset, respectively;
c) determining a normalized gradient field of each of the first and the second multi-dimensional image dataset and determining transform data in dependence thereupon;
d) using a texture unit of one of a Graphics Processing Unit (GPU) and General Purpose Graphics Processing Unit (GPGPU)transforming and interpolating the second multi-dimensional texture dataset using the transform data;
e) using the texture unit of the one of a GPU and GPGPU determining normalized gradient field metric data based on a calculation of an inner product between corresponding gradient vectors of normalized gradients of the first and the second multi-dimensional texture dataset;
f) using an optimization process adjusting the transform data in dependence upon the difference metric data;
g) iterating d) to f) until a stopping criterion is satisfied; and,
h) providing at least one of the transformed second multi-dimensional texture dataset and the transform data.

In accordance with the present invention there is yet further provided a storage medium having stored therein executable commands for execution on at least a processor, the at least a processor when executing the commands performing:

a) receiving a first and a second multi-dimensional image dataset, the first and the second multi-dimensional image dataset being indicative of an image of one of an object and a physical event;
b) determining a first and a second multi-dimensional texture dataset in dependence upon the first and the second multi-dimensional image dataset, respectively;
c) receiving transform data;
d) transforming and interpolating the second multi-dimensional texture dataset using the transform data;
e) determining difference metric data in dependence upon the first multi-dimensional texture dataset and the transformed second multi-dimensional texture dataset;
f) using an optimization process adjusting the transform data in dependence upon the difference metric data; and,
g) iterating d) to f) until a stopping criterion is satisfied.

In accordance with the present invention there is yet further provided a storage medium having stored therein executable commands for execution on at least a processor, the at least a processor when executing the commands performing:

a) receiving a first and a second multi-dimensional image dataset, the first and the second multi-dimensional image dataset being indicative of an image of one of an object and a physical event;
b) determining a first and a second multi-dimensional texture dataset in dependence upon the first and the second multi-dimensional image dataset, respectively;
c) generating a nonlinear vector deformation field texture dataset using transform data indicative of an identity transform;
d) using a texture unit of one of a Graphics Processing Unit (GPU) and General Purpose Graphics Processing Unit (GPGPU) transforming the second multi-dimensional texture dataset by indexing the nonlinear vector deformation field texture dataset producing a deformation index and using the deformation index indexing the second multi-dimensional texture dataset;
e) using the texture unit of the one of a GPU and GPGPU determining difference metric data in dependence upon the first multi-dimensional texture dataset and the transformed second multi-dimensional texture dataset;
f) using an optimization process adjusting the transform data in dependence upon the difference metric data;
g) using the texture unit of the one of a GPU and GPGPU adjusting the nonlinear vector deformation field texture dataset using the adjusted transform data;
h) iterating d) to g) until a stopping criterion is satisfied; and,
i) providing at least one of the transformed second multi-dimensional texture dataset and the transform data.

In accordance with the present invention there is yet further provided a storage medium having stored therein executable commands for execution on at least a processor, the at least a processor when executing the commands performing:

a) receiving a first and a second multi-dimensional image dataset, the first and the second multi-dimensional image dataset being indicative of an image of one of an object and a physical event;
b) determining a first and a second multi-dimensional texture dataset in dependence upon the first and the second multi-dimensional image dataset, respectively;
c) determining a normalized gradient field of each of the first and the second multi-dimensional image dataset and determining transform data in dependence thereupon;
d) using a texture unit of one of a Graphics Processing Unit (GPU) and General Purpose Graphics Processing Unit (GPGPU) transforming and interpolating the second multi-dimensional texture dataset using the transform data;
e) using the texture unit of the one of a GPU and GPGPU determining normalized gradient field metric data based on a calculation of an inner product between corresponding gradient vectors of normalized gradients of the first and the second multi-dimensional texture dataset;
f) using an optimization process adjusting the transform data in dependence upon the difference metric data;
g) iterating d) to f) until a stopping criterion is satisfied; and,
h) providing at least one of the transformed second multi-dimensional texture dataset and the transform data.

In accordance with the present invention there is yet further provided a system for registering multi-dimensional image data comprising:

an input port for receiving a first and a second multi-dimensional image dataset, the first and the second multi-dimensional image dataset being indicative of an image of one of an object and a physical event;
circuitry connected to the input port, the circuitry for:
a) determining a first and a second multi-dimensional texture dataset in dependence upon the first and the second multi-dimensional image dataset, respectively;
b) providing transform data;
c) transforming and interpolating the second multi-dimensional texture dataset using the transform data;
d) determining difference metric data in dependence upon the first multi-dimensional texture dataset and the transformed second multi-dimensional texture dataset;
e) using an optimization process adjusting the transform data in dependence upon the difference metric data; and,
f) iterating c) to e) until a stopping criterion is satisfied; and,
   an output port connected to the circuitry, the output port for providing at least one of the transformed second multi-dimensional texture dataset and the transform data.

### BRIEF DESCRIPTION OF THE FIGURES

Exemplary embodiments of the invention will now be described in conjunction with the following drawings, in which:

FIG. 1 is a simplified flow diagram illustrating a method for registering multi-dimensional image data according to the invention;

FIG. 2 is a simplified flow diagram illustrating a first detail of the method for registering multi-dimensional image data according to the invention shown in FIG. 1;

FIG. 3 is a simplified flow diagram illustrating a second detail of the method for registering multi-dimensional image data according to the invention shown in FIG. 1;

FIG. 4 is a simplified flow diagram illustrating a third detail of the method for registering multi-dimensional image data according to the invention shown in FIG. 1;

FIG. 5 is a simplified flow diagram illustrating a fifth detail of the method for registering multi-dimensional image data according to the invention shown in FIG. 1;

FIG. 6 is a simplified flow diagram illustrating a sixth detail of the method for registering multi-dimensional image data according to the invention shown in FIG. 1;

FIG. 7 is a simplified block diagram illustrating a first system implementation of the method for registering multi-dimensional image data according to the invention; and,

FIG. 8 is a simplified block diagram illustrating a second system implementation of the method for registering multi-dimensional image data according to the invention.

### DETAILED DESCRIPTION OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

In the following, it will become apparent to those skilled in the art that the invention, while being described in context with medical imaging, it is not limited thereto. There are numerous other beneficial applications of the invention in, for example, remote sensing, recognition, and tracking.

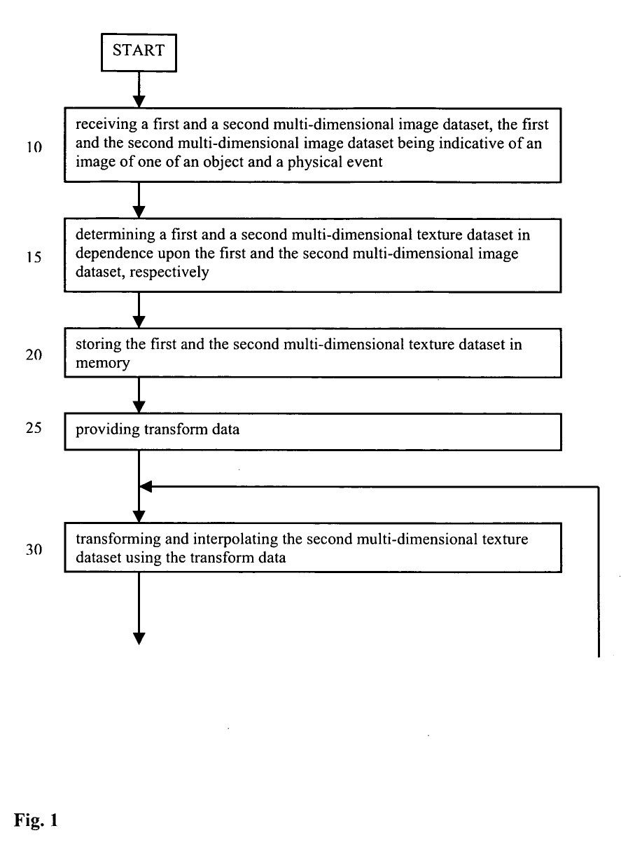

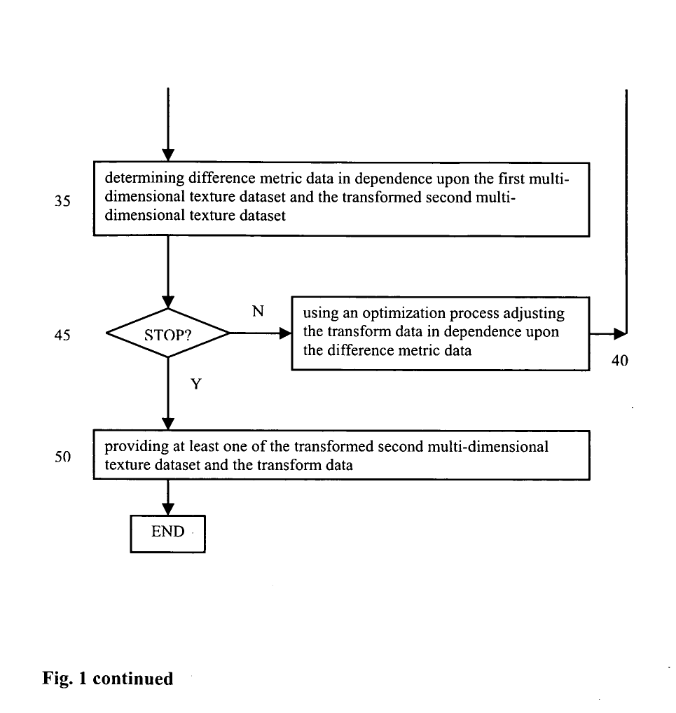

Referring to FIG. 1, a simplified flow diagram of a method for registering multi-dimensional image data according to the invention is shown. At 10 a first and a second multi-dimensional image dataset are received, for example, at a processor such as a Central Processing Unit (CPU) of a workstation. The first and the second multi-dimensional image dataset are indicative of an image of one of an object and a physical event. For example, the first and the second multi-dimensional image dataset are indicative of 3D medical images captured using a same image capturing process such as MRI or two different image capturing processes such as MRI and CT. At 15 a first and a second multi-dimensional texture dataset is determined in dependence upon the first and the second multi-dimensional image dataset, respectively. For example, the texture datasets are determined in conformity with a Read Green Blue Alpha (RGBA) format. Alternatively, other formats for describing texture are used such as RGB format. At 20 the texture datasets are stored in memory, for example, Video Random Access Memory (VRAM), of a graphics processor such as a Graphics Processing Unit (GPU) or a General Purpose Graphics Processing Unit (GPGPU). At 25 transform data are provided. The goal of the registration process is to align the second multi-dimensional texture dataset—moving image—with the first multi-dimensional texture dataset—fixed or target image. A transform is used to map points between the fixed and moving image for a given set of transform data. Various methods for providing the transform data will be described below. At 30 the second multi-dimensional texture dataset is then transformed using the transform data. As will be described below, there are different transform processes—linear and non-linear—applicable, which are, for example, selected by a user depending on the images to be registered. When a point is mapped from one image space to another image space, it will generally be mapped to a non-grid position. Therefore, interpolation is employed to determine texture data at the mapped position. Depending on the transformation process used different interpolation techniques are employed, as will be described below. At 35 difference metric data are determined in dependence upon the first multi-dimensional texture dataset and the transformed second multi-dimensional texture dataset. The difference metric represents a similarity measure between the fixed image and the moving image, i.e. it indicates how well the fixed image is matched by the transformed moving image. For example, the difference metric data are determined at points within a predetermined region of the fixed image. Various methods for determining the difference metric data will be described below. The difference metric data are then used as a quantitative criterion to be improved in an improvement process—at 40—over a search space defined by the transform data. Using the improvement process the transform data are adjusted in dependence upon the difference metric data. Various optimization processes are employed as improvement process as will be described below. The steps at 30, 35, and 40 are iterated until a stopping criterion is satisfied—45—and the transformed second multi-dimensional texture dataset or the transform data are then provided—at 50. The stopping criterion is, for example, a stopping signal received from a user, a predetermined maximum number of iterations, a predetermined threshold of the difference metric data, or a predetermined threshold for use in the optimization process.

In the method for registering multi-dimensional image data according to the invention the transformation, the interpolation and the determination of the difference metric data are performed by processing texture data. This allows, for example, use of a texture unit of the GPU or the GPGPU for the processing intensive steps of the registration with the texture data being stored in VRAM of the GPU or the GPGPU, while only the initialization and the optimization are performed using the CPU. Since the optimization process operates only on small data sets the transfer of data between the GPU and the CPU during the iteration is only minor and does not substantially adversely affect the processing speed which is substantially higher than the processing speed of the state of the art. Furthermore, with the advance of next generation GPGPUs it will likely be possible to also perform the optimization process using the GPGPU.

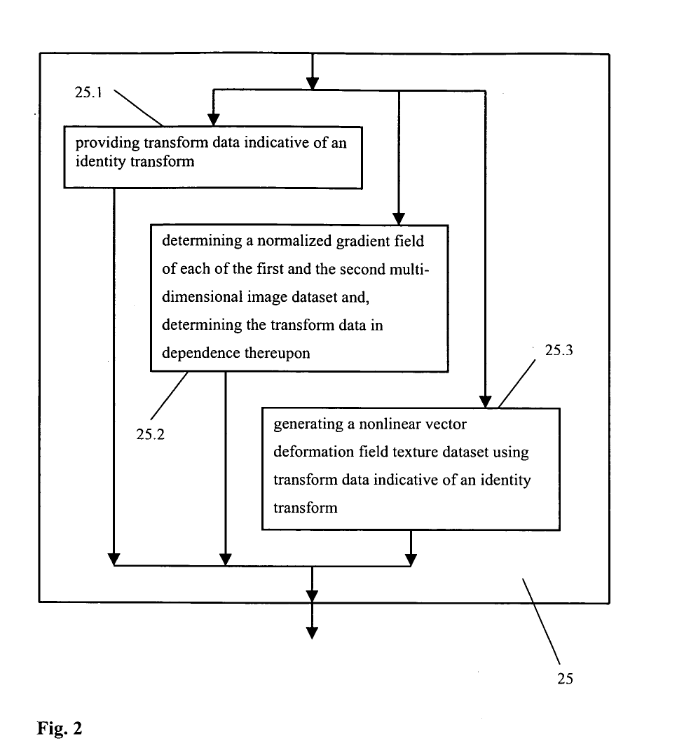

Referring to FIG. 2, a simplified flow diagram illustrating various methods of providing the transform data in step 25 according to the invention is shown. At 25.1 transform data indicative of an identity transform are provided. For example, the transform data are stored in memory and retrieved therefrom. At 25.2 a normalized gradient field of each of the first and the second multi-dimensional image dataset are determined and the transform data are then determined in dependence thereupon. At 25.3 a nonlinear vector deformation field texture dataset is generated using transform data indicative of an identity transform. The nonlinear vector deformation field texture dataset is then stored, for example, in the VRAM of the GPU or the GPGPU and adjusted using the adjusted transform data during each iteration.

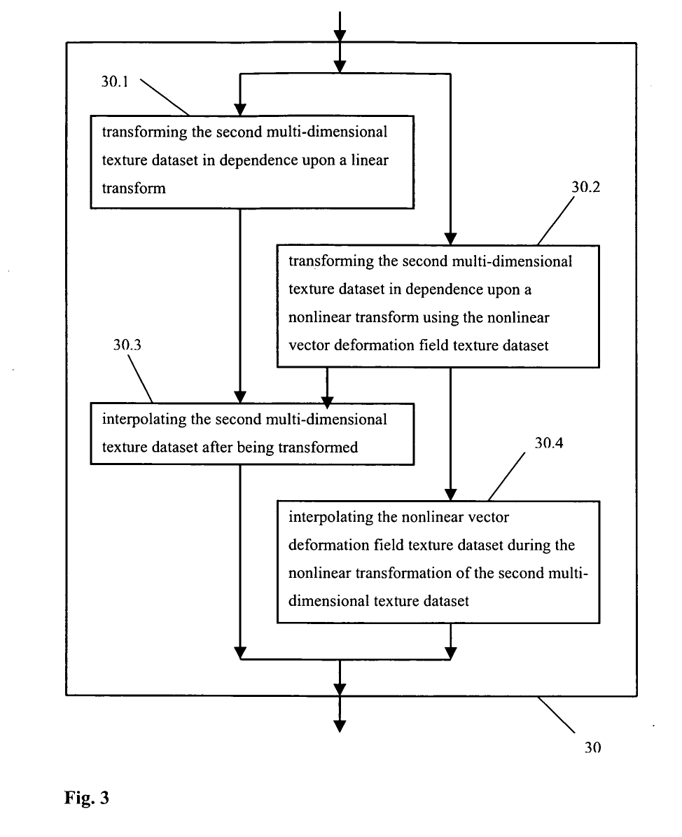

Referring to FIG. 3, a simplified flow diagram illustrating various methods of transformation and interpolation of the second multi-dimensional texture dataset in step 30 according to the invention is shown. At 30.1 the second multi-dimensional texture dataset is transformed in dependence upon a linear transform. For example, the linear transform is a rigid 6-degree-of-freedom or a scaling 9-degree-of-freedom transform. The linear rigid transform is most commonly used because it has relatively few parameters to be determined and, therefore, requires less processing than other transforms. At 30.2 the second multi-dimensional texture dataset is transformed in dependence upon a nonlinear transform using the nonlinear vector deformation field texture dataset. For example, using the texture unit of the GPU or the GPGPU the second multi-dimensional texture dataset is transformed by indexing the nonlinear vector deformation field texture dataset producing a deformation index and using the deformation index for indexing the second multi-dimensional texture dataset. At 30.3 the second multi-dimensional texture dataset is interpolated after being transformed using, for example, trilinear interpolation for a 3D texture dataset. Other interpolation processes such as nearest neighbor interpolation or higher order interpolation are also applicable once they are supported by next generation GPUs or next generation GPGPUs. At 30.4 the nonlinear vector deformation field texture dataset is interpolated during the nonlinear transformation of the second multi-dimensional texture dataset. Again, trilinear interpolation for a 3D texture dataset is used.

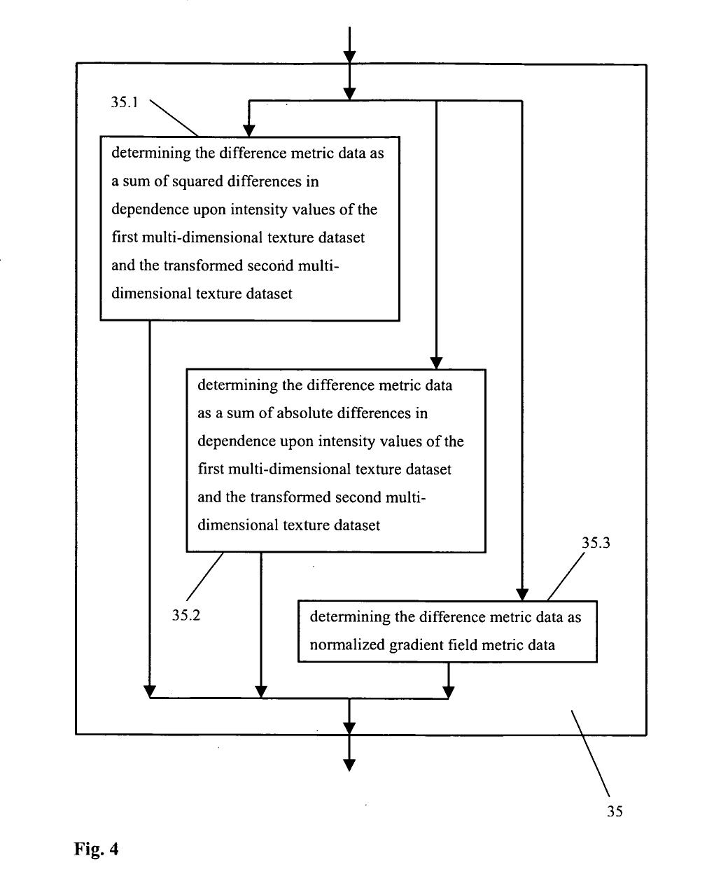

Referring to FIG. 4, a simplified flow diagram illustrating various methods of determining the difference metric data in step 35 according to the invention is shown. At 35.1 the difference metric data are determined as a Sum of Squared Differences (SSD) metric in dependence upon intensity values of the first multi-dimensional texture dataset and the transformed second multi-dimensional texture dataset. For example, the intensity values of the first multi-dimensional texture dataset and the transformed second multi-dimensional texture dataset are subtracted from each other to produce subtraction results, which are then squared and summed to produce a single value. At 35.2 the difference metric data are determined as a Sum of Absolute Differences (SAD) metric in dependence upon intensity values of the first multi-dimensional texture dataset and the transformed second multi-dimensional texture dataset. For example, the intensity values of the first multi-dimensional texture dataset and the transformed second multi-dimensional texture dataset are subtracted from each other to produce subtraction results, absolute values of the subtraction results are then determined and summed to produce a single value. At 35.3 the difference metric data are determined as normalized gradient field metric data. For example, normalized gradient field metric data are determined by calculating an inner product between corresponding gradient vectors of normalized gradients of the first and the second multi-dimensional texture dataset, negating the inner products, and summing the results to produce a single value. For example, the difference metric data are determined at 35.1 to 35.3 using the texture unit of the GPU or the GPGPU.

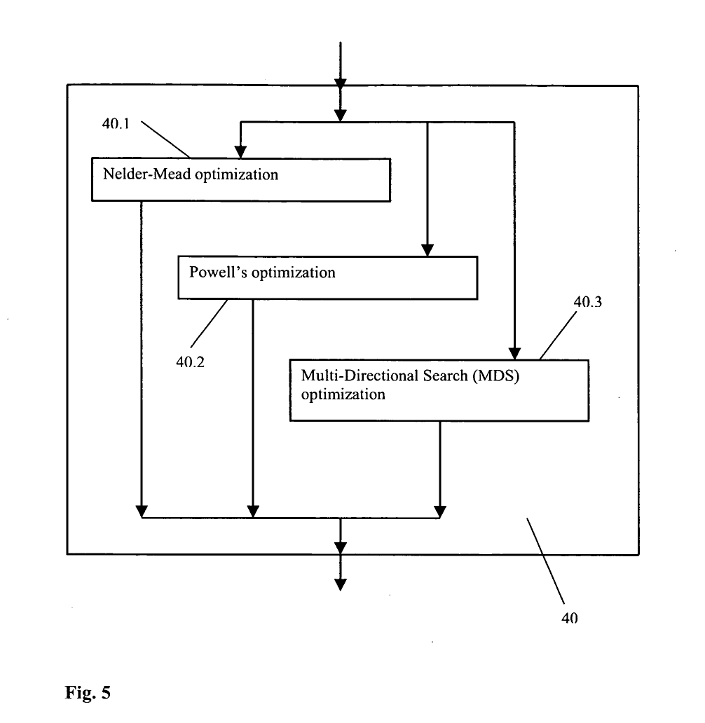

Referring to FIG. 5, a simplified flow diagram illustrating various optimization processes of step 40 according to the invention is shown. At 40.1 Nelder-Mead optimization—downhill simplex—is used for the numeric optimization of the transform data. At 40.2 Powell's optimization and at 40.3 Multi-Directional Search (MDS) optimization is used for the numeric optimization of the transform data. The above optimization processes have been chosen as examples, but the method for registering multi-dimensional image data according to the invention is not limited thereto. Optimization processes are well known and one skilled in the art will readily arrive at numerous other optimization processes for use with the present invention.

The various implementations shown in the FIGS. 2 to 5 are easily incorporated into the respective steps of the method for registering multi-dimensional image data according to the invention shown in FIG. 1, enabling a user to choose numerous different combinations thereof depending on the image data to be registered. Possible applications of the various implementations are, for example, as follows:
25.1—all; 25.2—multi-modality; 25.3—nonlinear transformation;
30.1—linear transformation; 30.2—nonlinear transformation; 30.3—all; 30.4—nonlinear transformation;
35.1, 35.2—single-modality; 35.3—multi-modality; and
40.1, 40.2, 40.3—all.

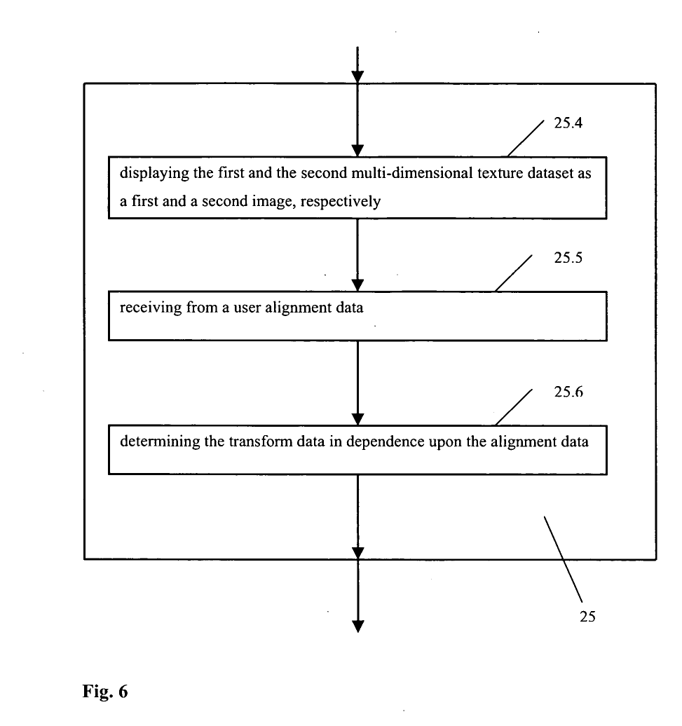

Referring to FIG. 6, a simplified flow diagram illustrating various methods of providing the transform data in step 25 according to the invention is shown. At 25.4 the first and the second multi-dimensional texture dataset are displayed as a first and a second image. A user then graphically aligns the second image with the first image, for example, by graphically moving the second image in x, y, and z direction and by rotating the same. User alignment data indicative of the alignment performed by the user are then provided—at 25.5—and the transform data are then determined in dependence upon the user alignment data—at 25.6. For example, in some situations a practitioner is able to quickly recognize certain features contained in both images and to quickly align the respective features, thus quickly providing a first coarse alignment. Using transform data determined in such a fashion allows in some situations to reduce the time needed for registering the two images.

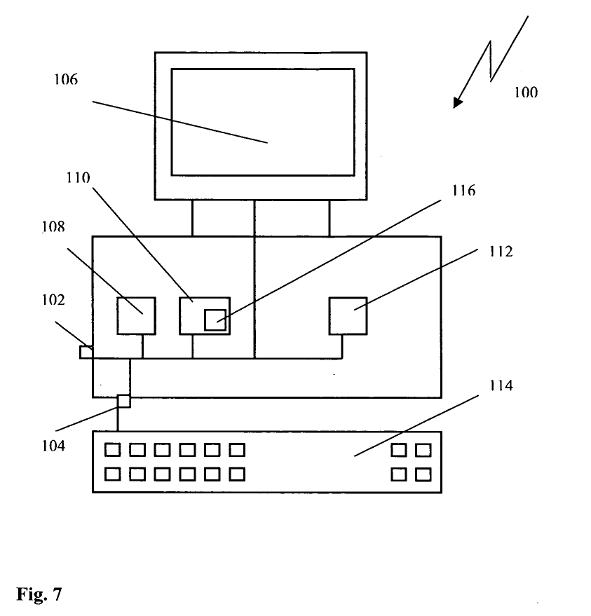

Referring to FIG. 7, a processing system 100 according to the invention for implementing the above method for registering multi-dimensional image data is shown. A first and a second multi-dimensional image dataset are received at input port 102. Using electronic circuitry such as a CPU 108 and a GPU or GPGPU 110 the datasets are then digitally processed as described above. The system 100 comprises a storage medium 112 having stored therein executable commands for execution on the CPU 108 and the GPU or GPGPU 110 for performing the processing according to the above method. Alternatively, the electronic circuitry is designed for performing at least a portion of the processing in a hardware implemented fashion. The system 100 further comprises memory 116 such as VRAM in communication with the GPU or the GPGPU 110 for storing data during execution. The processing is controlled by a user viewing, for example, a graphical representation of the registered data and by providing control commands via port 104—connected, for example, to a keyboard 114- to the CPU 108. Optionally, the display 106 is a graphical user interface facilitating user interaction during processing. Optionally, the electronic circuitry comprises a Field Programmable Gate Array (FPGA).

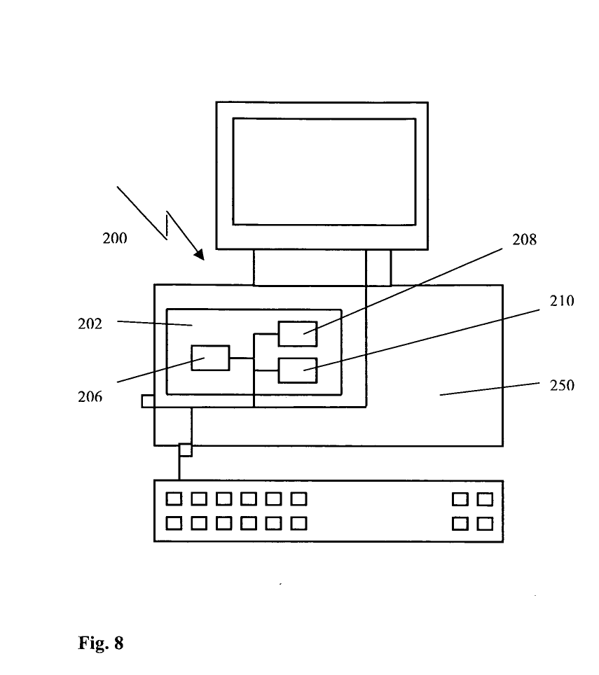

Referring to FIG. 8, another processing system 200 according to the invention for implementing the above method for registering multi-dimensional image data is shown. Here, electronic circuitry such as a CPU 208 and a GPU or GPGPU 210 is disposed on a Printed Circuit Board (PCB) 202, which is inserted into an expansion slot of a host system 250 and has an interface for connection to, for example, a USB bus system thereof. The system 200 comprises a storage medium 206 having stored therein executable commands for execution on the CPU 208 and the GPU or GPGPU 210 for performing the processing according to the above method. Alternatively, the electronic circuitry is designed for performing at least a portion of the processing in a hardware implemented fashion.

Numerous other embodiments of the invention will be apparent to persons skilled in the art without departing from the spirit and scope of the invention as defined in the appended claims.

What is claimed is:

1. A method for registering multi-dimensional image data comprising:
a) providing a first and a second multi-dimensional image dataset, the first and the second multi-dimensional image dataset being indicative of an image of one of an object and a physical event;
b) determining a first and a second multi-dimensional texture dataset in dependence upon the first and the second multi-dimensional image dataset, respectively;
c) providing transform data;
d) transforming and interpolating the second multi-dimensional texture dataset using the transform data;
e) determining difference metric data in dependence upon the first multi-dimensional texture dataset and the transformed second multi-dimensional texture dataset;
f) using an improvement process adjusting the transform data in dependence upon the difference metric data; and,
g) iterating d) to f) until a stopping criterion is satisfied.

2. A method for registering multi-dimensional image data as defined in claim 1 comprising providing at least one of the transformed second multi-dimensional texture dataset and the transform data.

3. A method for registering multi-dimensional image data as defined in claim 2 wherein at least d) and e) are performed using a graphics processor.

4. A method for registering multi-dimensional image data as defined in claim 2 wherein at least d) and e) are performed using a texture unit of one of a Graphics Processing Unit (GPU) and General Purpose Graphics Processing Unit (GPGPU).

5. A method for registering multi-dimensional image data as defined in claim 4 comprising storing the first and the second multi-dimensional texture dataset in Video Random Access Memory (VRAM) of the one of a GPU and GPGPU.

6. A method for registering multi-dimensional image data as defined in claim 2 wherein c) the provided transform data are indicative of an identity transform.

7. A method for registering multi-dimensional image data as defined in claim 2 comprising:
determining a normalized gradient field of each of the first and the second multi-dimensional image dataset; and,
determining the transform data in dependence thereupon.

8. A method for registering multi-dimensional image data as defined in claim 2 comprising:
generating a nonlinear vector deformation field texture dataset using transform data indicative of an identity transform; and,
adjusting the nonlinear vector deformation field texture dataset using the adjusted transform data.

9. A method for registering multi-dimensional image data as defined in claim 2 wherein d) the second multi-dimensional texture dataset is transformed in dependence upon a linear transform.

10. A method for registering multi-dimensional image data as defined in claim 9 wherein the linear transform is one of a rigid transform and a scaling transform.

11. A method for registering multi-dimensional image data as defined in claim 2 wherein d) the second multi-dimensional texture dataset is transformed in dependence upon a nonlinear transform.

12. A method for registering multi-dimensional image data as defined in claim 8 wherein d) the second multi-dimensional texture dataset is transformed in dependence upon a nonlinear transform using the nonlinear vector deformation field texture dataset.

13. A method for registering multi-dimensional image data as defined in claim 2 wherein d) the second multi-dimensional texture dataset is interpolated after being transformed.

14. A method for registering multi-dimensional image data as defined in claim 12 wherein d) the nonlinear vector deformation field texture dataset is interpolated during the nonlinear transformation of the second multi-dimensional texture dataset.

15. A method for registering multi-dimensional image data as defined in claim 2 wherein e) the difference metric data are determined as a sum of squared differences in dependence upon intensity values of the first multi-dimensional texture dataset and the transformed second multi-dimensional texture dataset.

16. A method for registering multi-dimensional image data as defined in claim 2 wherein e) the difference metric data are determined as a sum of absolute differences in dependence upon intensity values of the first multi-dimensional texture dataset and the transformed second multi-dimensional texture dataset.

17. A method for registering multi-dimensional image data as defined in claim 7 wherein e) the difference metric data are determined as normalized gradient field metric data.

18. A method for registering multi-dimensional image data as defined in claim 2 wherein f) a Nelder-Mead optimization process is used.

19. A method for registering multi-dimensional image data as defined in claim 2 wherein f) a Powell's optimization process is used.

20. A method for registering multi-dimensional image data as defined in claim 2 wherein f) a multi-directional search optimization process is used.

21. A method for registering multi-dimensional image data as defined in claim 2 wherein the stopping criterion comprises one of:
a stopping signal received from a user;
a predetermined maximum number of iterations;
a predetermined threshold of the difference metric data; and,
a predetermined threshold for use in the improvement process.

22. A method for registering multi-dimensional image data as defined in claim 2 wherein b) the first and the second multi-dimensional texture dataset are determined in conformity with a Read Green Blue Alpha (RGBA) format.

23. A method for registering multi-dimensional image data as defined in claim 2 wherein a) the first and the second multi-dimensional image dataset are provided with the first and the second multi-dimensional image dataset being indicative of the images captured using a same image capturing process.

24. A method for registering multi-dimensional image data as defined in claim 2 wherein a) the first and the second multi-dimensional image dataset are provided with the first and the second multi-dimensional image dataset being indicative of the images captured using different image capturing processes.

25. A method for registering multi-dimensional image data as defined in claim 2 wherein c) comprises:
displaying the first and the second multi-dimensional texture dataset;
receiving from a user alignment data; and,
determining the transform data in dependence upon the alignment data.

26. A method for registering multi-dimensional image data comprising:
a) providing a first and a second multi-dimensional image dataset, the first and the second multi-dimensional image dataset being indicative of an image of one of an object and a physical event;
b) determining a first and a second multi-dimensional texture dataset in dependence upon the first and the second multi-dimensional image dataset, respectively;
c) generating a nonlinear vector deformation field texture dataset using transform data indicative of an identity transform;
d) using a texture unit of one of a Graphics Processing Unit (GPU) and General Purpose Graphics Processing Unit (GPGPU) transforming the second multi-dimensional texture dataset by indexing the nonlinear vector deformation field texture dataset producing a deformation index and using the deformation index indexing the second multi-dimensional texture dataset;
e) using the texture unit of the one of a GPU and GPGPU determining difference metric data in dependence upon the first multi-dimensional texture dataset and the transformed second multi-dimensional texture dataset;
f) using an improvement process adjusting the transform data in dependence upon the difference metric data;
g) using the texture unit of the one of a GPU and GPGPU adjusting the nonlinear vector deformation field texture dataset using the adjusted transform data;
h) iterating d) to g) until a stopping criterion is satisfied; and,
i) providing at least one of the transformed second multi-dimensional texture dataset and the transform data.

27. A method for registering multi-dimensional image data as defined in claim 26 wherein d) the nonlinear vector deformation field texture dataset is interpolated during the nonlinear transformation of the second multi-dimensional texture dataset.

28. A method for registering multi-dimensional image data as defined in claim 26 comprising storing the first and the second multi-dimensional texture dataset and the nonlinear vector deformation field texture dataset in Video Random Access Memory (VRAM) of the one of a GPU and a GPGPU.

29. A method for registering multi-dimensional image data comprising:
a) providing a first and a second multi-dimensional image dataset, the first and the second multi-dimensional image dataset being indicative of an image of one of an object and a physical event;
b) determining a first and a second multi-dimensional texture dataset in dependence upon the first and the second multi-dimensional image dataset, respectively;
c) determining a normalized gradient field of each of the first and the second multi-dimensional image dataset and determining transform data in dependence thereupon;
d) using a texture unit of one of a Graphics Processing Unit (GPU) and General Purpose Graphics Processing Unit (GPGPU)transforming and interpolating the second multi-dimensional texture dataset using the transform data;
e) using the texture unit of the one of a GPU and GPGPU determining normalized gradient field metric data based on a calculation of an inner product between corresponding gradient vectors of normalized gradients of the first and the second multi-dimensional texture dataset;
f) using an improvement process adjusting the transform data in dependence upon the difference metric data;
g) iterating d) to f) until a stopping criterion is satisfied; and,
h) providing at least one of the transformed second multi-dimensional texture dataset and the transform data.

30. A method for registering multi-dimensional image data as defined in claim 29 comprising storing the first and the second multi-dimensional texture dataset in Video Random Access Memory (VRAM) of the one of a GPU and GPGPU.

31. A storage medium having stored therein executable commands for execution on at least a processor, the at least a processor when executing the commands performing:
a) receiving a first and a second multi-dimensional image dataset, the first and the second multi-dimensional image dataset being indicative of an image of one of an object and a physical event;
b) determining a first and a second multi-dimensional texture dataset in dependence upon the first and the second multi-dimensional image dataset, respectively;
c) receiving transform data;
d) transforming and interpolating the second multi-dimensional texture dataset using the transform data;
e) determining difference metric data in dependence upon the first multi-dimensional texture dataset and the transformed second multi-dimensional texture dataset;
f) using an improvement process adjusting the transform data in dependence upon the difference metric data; and,
g) iterating d) to f) until a stopping criterion is satisfied.

32. A storage medium having stored therein executable commands for execution on at least a processor, the at least a processor when executing the commands performing:
a) receiving a first and a second multi-dimensional image dataset, the first and the second multi-dimensional image dataset being indicative of an image of one of an object and a physical event;
b) determining a first and a second multi-dimensional texture dataset in dependence upon the first and the second multi-dimensional image dataset, respectively;
c) generating a nonlinear vector deformation field texture dataset using transform data indicative of an identity transform;
d) using a texture unit of one of a Graphics Processing Unit (GPU) and General Purpose Graphics Processing Unit (GPGPU) transforming the second multi-dimensional texture dataset by indexing the nonlinear vector deformation field texture dataset producing a deformation index and using the deformation index indexing the second multi-dimensional texture dataset;
e) using the texture unit of the one of a GPU and GPGPU determining difference metric data in dependence upon the first multi-dimensional texture dataset and the transformed second multi-dimensional texture dataset;
f) using an improvement process adjusting the transform data in dependence upon the difference metric data;
g) using the texture unit of the one of a GPU and GPGPU adjusting the nonlinear vector deformation field texture dataset using the adjusted transform data;
h) iterating d) to g) until a stopping criterion is satisfied; and,
i) providing at least one of the transformed second multi-dimensional texture dataset and the transform data.

33. A storage medium having stored therein executable commands for execution on at least a processor, the at least a processor when executing the commands performing:
a) receiving a first and a second multi-dimensional image dataset, the first and the second multi-dimensional image dataset being indicative of an image of one of an object and a physical event;
b) determining a first and a second multi-dimensional texture dataset in dependence upon the first and the second multi-dimensional image dataset, respectively;
c) determining a normalized gradient field of each of the first and the second multi-dimensional image dataset and determining transform data in dependence thereupon;
d) using a texture unit of one of a Graphics Processing Unit (GPU) and General Purpose Graphics Processing Unit (GPGPU) transforming and interpolating the second multi-dimensional texture dataset using the transform data;
e) using the texture unit of the one of a GPU and GPGPU determining normalized gradient field metric data based on a calculation of an inner product between corresponding gradient vectors of normalized gradients of the first and the second multi-dimensional texture dataset;
f) using an improvement process adjusting the transform data in dependence upon the difference metric data;
g) iterating d) to f) until a stopping criterion is satisfied; and,
h) providing at least one of the transformed second multi-dimensional texture dataset and the transform data.

34. A system for registering multi-dimensional image data comprising:
an input port for receiving a first and a second multi-dimensional image dataset, the first and the second multi-dimensional image dataset being indicative of an image of one of an object and a physical event;
circuitry connected to the input port, the circuitry for:
a) determining a first and a second multi-dimensional texture dataset in dependence upon the first and the second multi-dimensional image dataset, respectively;
b) providing transform data;
c) transforming and interpolating the second multi-dimensional texture dataset using the transform data;
d) determining difference metric data in dependence upon the first multi-dimensional texture dataset and the transformed second multi-dimensional texture dataset;
e) using an improvement process adjusting the transform data in dependence upon the difference metric data; and,
f) iterating c) to e) until a stopping criterion is satisfied; and,
an output port connected to the circuitry, the output port for providing at least one of the transformed second multi-dimensional texture dataset and the transform data.

35. A system for registering multi-dimensional image data as defined in claim 34 wherein the circuitry comprises a graphics processor for performing at least c) and d).

36. A system for registering multi-dimensional image data as defined in claim 35 wherein the graphics processor is one of a Graphics Processing Unit (GPU) and General Purpose Graphics Processing Unit (GPGPU).

37. A system for registering multi-dimensional image data as defined in claim 35 wherein the circuitry comprises a Central Processing Unit (CPU).
